(19) United States
(12) Patent Application Publication
(10) Pub. No.: US 2011/0166906 A1
(43) Pub. Date: Jul. 7, 2011

(54) Concentration Risk Modeling

(75) Inventors: Lee J. Hardee, Charlotte, NC (US); Ruben C. Berumen, Miami, FL (US); Anurag Amatya, Denver, CO (US); Kenton C. Smith, Monroe, NC (US); Jason Daniel Latta, Charlotte, NC (US); Richard T. Mattingly, Charlotte, NC (US)

(73) Assignee: BANK OF AMERICA CORPORATION, Charlotte, NC (US)

(21) Appl. No.: 12/900,630

(22) Filed: Oct. 8, 2010

Related U.S. Application Data
(63) Continuation-in-part of application No. 12/651,663, filed on Jan. 4, 2010.

(51) Int. Cl. G06Q 10/00

(52) U.S. Cl. 705/7.28

(57) ABSTRACT

A system and method of calculating a concentration risk score for a work process at an organization center are provided. The concentration risk score may be based on a redundancy score and a criticality score. In some examples, the redundancy score may be determined based on a percentage of total resources associated with the work process at a first center. The redundancy score and criticality score may then be combined to determine a concentration risk score for the work process at that center.

### CROSS REFERENCE TO RELATED APPLICATIONS

This application is a continuation-in-part of pending application Ser. No. 12/651,663, filed Jan. 4, 2010, and entitled “Concentration Risk Modeling,” the content of which is incorporated herein by reference in its entirety.

### BACKGROUND

The term “concentration risk” is sometimes used to refer to the risk of over-concentrating organizational resources. For example, if an organization concentrates its employees in a small number of centers and one of those centers experiences a disruption, then the organization's operational continuity will likely be disrupted. Organizations typically face a tradeoff between increasing managerial efficiency by locating employees in small number of centers and mitigating concentration risk by distributing those employees over a larger number of centers located in a number of different locations or areas.

Organizations are constantly searching for methodologies to determine an appropriate balance between minimizing concentration risk and maximizing efficiencies without exceeding the respective organization's risk tolerance. According to current methodologies, to evaluate concentration risks, some organizations simply perform a high-level review to determine the level of location distribution among its employees. The results of this high-level review are measured against the organization's concentration-risk threshold, which represents the organization's risk tolerance. For example, a common concentration-risk threshold is a percentage of the organization's total number of employees. In this case, for the organization's concentration risk to be considered acceptable, no single center within the organization can house more than a threshold percentage of the organization's total number of employees. Accordingly, if, after executing the high-level review, the organization determines that no single center houses more than the threshold percentage of the organization's employees, then the organization determines that its concentration risk is acceptable. However, if a single center houses more than the threshold percentage of the organization's employees, then the concentration risk is consider unacceptably high.

However, these known methodologies result in inaccurate or incomplete models because they do not consider the criticality of the various processes performed by the employees. Nor do these known methodologies consider the organization's readiness and capability of migrating work from one center to another center in the event of an operational disruption.

In addition to sometimes being inaccurate and incomplete, these known methodologies contemplate high-level reviews that are executed on an ad-hoc basis and that merely provide a snapshot of the organization at the time of the review. Thus, these current methodologies are inherently retrospective and put the organization's decision-makers in a position where they have to react to the results of the high-level reviews, instead of proactively managing the organization. In sum, these known methodologies have a number of inadequacies that impede decision-makers from being able to accurately and comprehensively model concentration risk on a continuous and forward looking basis to enable proactive decision making.

Accordingly, there is a need for systems, devices, methods, and other tools that allow an organization to obtain a comprehensive and accurate model of its concentration risks.

### SUMMARY

The following presents a simplified summary in order to provide a basic understanding of some aspects of the present disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below

Concentration risk refers to the risk of over-concentrating organizational resources. For example, if an organization over-concentrates its employees that work on a particular process in a small number of locations, then, depending on the importance of the particular process, the organization assumes the risk that its operational continuity may be disrupted and/or that its customers will be negatively impacted if one of those locations experiences a disruption. Embodiments of the present disclosure assess the redundancy and criticality of each identified process within the organization, where redundancy refers to the organization's capacity to move work on a particular process from one center to another center in the event a disruption occurs at one of the centers and where criticality refers to the importance of a particular process to the organization. Based the redundancy and criticality assessments, embodiments of the present disclosure calculate a concentration-risk score for each of the identified processes within an organization.

In an embodiment, a system is provided for determining the concentration risk for a process within an organization. According to this embodiment, the system includes a user interface and a memory device, which comprises: computer-readable program code; integrated-adoption data relating to redundancy of the process; and criticality-to-organization data relating to criticality of the process. The system, according to this embodiment, further comprises a processor operatively coupled to the user interface and the memory device and configured to: execute the computer-readable program code to: receive, via the user interface, process-identifying information comprising an identification of the process; locate in the memory device using the process-identifying information the integrated-adoption data and the criticality-to organization data; utilize the integrated-adoption data to calculate a redundancy score that measures the redundancy of the process; utilize the criticality-to-organization data to calculate a criticality score that measures the criticality of the process; and utilize the redundancy score and the criticality score to calculate a concentration-risk score for the process.

In another embodiment, a method is provided for determining the concentration risk for a process within an organization. According to this embodiment, the method comprises: storing integrated-adoption data relating to the redundancy of the process; storing criticality-to-organization data relating to the criticality of the process; utilizing the integrated-adoption data to calculate a redundancy score that measures the redundancy of the process; utilizing the criticality-to-organization data to calculate a criticality score that measures the criticality of the process; and utilizing the redundancy score and the criticality score to calculate a concentration-risk score for the process.

In yet another embodiment, a computer program product is provided for determining the concentration risk for a process within an organization comprising a computer-readable medium having computer-readable program code stored therein. According to this embodiment, the computer-readable program code comprises: a first code portion configured to store integrated-adoption data relating to redundancy of the process; a second code portion configured to store criticality-to-organization data relating to criticality of the process; a third code portion configured to utilize the integrated-adoption data to calculate a redundancy score that measures the redundancy of the process; a fourth code portion configured to utilize the criticality-to-organization data to calculate a criticality score that measures criticality of the process; and a fifth code portion configured to utilize the redundancy score and the criticality score to calculate a concentration-risk score for the process.

In still other examples, systems and methods are provided to calculate a concentration risk score based on a redundancy score and a criticality score. In at least some arrangements, the redundancy score may be based on or equal to a percentage of total resources associated with a work process at a first center. The redundancy score and determined criticality score may be transmitted to a concentration risk calculating module and a concentration risk score may be determined.

### BRIEF DESCRIPTION OF THE DRAWINGS

Reference will now be made to the accompanying drawings to describe some aspects of the disclosure, wherein:

FIG. 1 provides a block diagram of a concentration-risk modeling environment in which the concentration-risk modeling processes of the present disclosure are carried out, in accordance with one embodiment of the present disclosure;

FIG. 2 provides a table that lists four exemplary redundancy components, brief exemplary descriptions of each of the exemplary redundancy components, and exemplary scoring criteria for each of the exemplary redundancy components, in accordance with one embodiment of the present disclosure;

FIG. 3 provides a flow diagram illustrating a process whereby an organization utilizes the concentration-risk modeling environment of FIG. 1 to calculate a redundancy score for a process within the organization, in accordance with an embodiment of the present disclosure;

FIG. 4 provides an exemplary redundancy score table that lists five exemplary processes within an exemplary organization and, for each of the five exemplary processes, the exemplary redundancy score table lists an exemplary location-dispersion score, an exemplary migration-capacity score, an exemplary access-to-same-systems score, an exemplary testing score, and an exemplary redundancy score, in accordance with an embodiment of the present disclosure;

FIG. 5 provides a table that lists three exemplary criticality components, brief exemplary descriptions of each of the exemplary criticality components, and exemplary scoring criteria for each of the exemplary criticality components, in accordance with one embodiment of the present disclosure;

FIG. 6 provides a flow diagram illustrating a process whereby an organization utilizes a concentration-risk modeling environment of FIG. 1 to calculate a criticality score for a particular process within the organization, in accordance with an embodiment of the present disclosure;

FIG. 7 provides an exemplary criticality-component-score table that lists the same five exemplary processes within an organization as listed in the table of FIG. 4; for each of the five exemplary processes, the exemplary criticality-component-score table lists a service-delivery-impact score, an enterprise-impact score, an operational-impact score, and an average-criticality-component score, in accordance with an embodiment of the present disclosure;

FIG. 8 provides an exemplary component-to-criticality conversion table that lists three exemplary ranges of average-criticality-component scores and corresponding criticality scores, in accordance with an embodiment of the present disclosure;

FIG. 9 provides an exemplary table that lists the same five exemplary processes within an organization as listed in the tables of FIGS. 4 and 7; for each of the five exemplary processes, the exemplary table lists the redundancy scores that were calculated according to the process of FIG. 3 and that are listed in FIG. 4, the criticality scores that were calculated according to the process of FIG. 6 and that are listed in FIG. 7, and concentration-risk scores, according to an embodiment of the present disclosure;

FIG. 10 illustrates another example concentration risk modeling system or environment according to one or more aspects described herein;

FIG. 11 illustrates an example method of calculating a redundancy score based on a percentage of total resources associated with a work process at a center according to one or more aspects described herein;

FIG. 12 illustrates an example table of calculated redundancy scores for various processes and centers based on the percentage of total resources associated with a work process at a center according to one or more aspects described herein;

FIG. 13 illustrates one example method of determining a concentration risk score based on the redundancy score and criticality score according to one or more aspects described herein; and

FIGS. 14A-14D illustrate example tables of calculated concentration risk scores based on the determined redundancy score and criticality score according to one or more aspects described herein.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Like numbers refer to like elements throughout.

As will be appreciated by one of ordinary skill in the art in view of this disclosure, the present disclosure may be embodied as a method, system, apparatus, computer program product, or a combination of the foregoing. Accordingly, embodiments of the present disclosure may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present disclosure may take the form of a computer program product comprising a non-transitory computer-readable medium having computer-usable program code embodied in the medium.

Any suitable computer-readable medium may be utilized, including a computer-readable storage medium and/or a computer-readable signal medium. A non-transitory computer-readable storage medium may be, for example but not limited to, an electronic, magnetic, optical, electromagnetic, infrared, or semiconductor storage system, apparatus, or device. More specific examples of the non-transitory computer-readable storage medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

Computer program code for carrying out operations of embodiments of the present disclosure may be written in an object-oriented, scripted or unscripted programming language such as Java, Pen, Smalltalk, C-HE, or the like. However, the computer program code for carrying out operations of embodiments of the present disclosure may also be written in conventional procedural programming languages, such as the “C” programming language or similar programming languages.

Embodiments of the present disclosure are described below with reference to flowchart illustrations and/or block diagrams of methods, apparatus (systems), and computer program products. It will be understood that each block of the flowchart illustrations, and/or combinations of blocks in the flowchart illustrations, can be implemented by computer program instructions. These computer program instructions may be provided to a processor of a general purpose computer, special purpose computer, or other programmable data processing apparatus to produce a particular machine, such that the instructions, which execute via the processor of the computer or other programmable data processing apparatus, create mechanisms for implementing the functions/acts specified in the flowchart block or blocks.

These computer program instructions may also be stored in a non-transitory computer-readable memory that can direct a computer or other programmable data processing apparatus to function in a particular manner, such that the instructions stored in the computer-readable memory produce an article of manufacture, including instruction means which implement the function/act specified in the flowchart block(s).

The computer program instructions may also be loaded onto a computer or other programmable data processing apparatus to cause a series of operational steps to be performed on the computer or other programmable apparatus to produce a computer-implemented process, such that the instructions which execute on the computer or other programmable apparatus provide steps for implementing the functions/acts specified in the flowchart block(s). Alternatively, computer program implemented steps or acts may be combined with operator or human implemented steps or acts in order to carry out an embodiment of the disclosure.

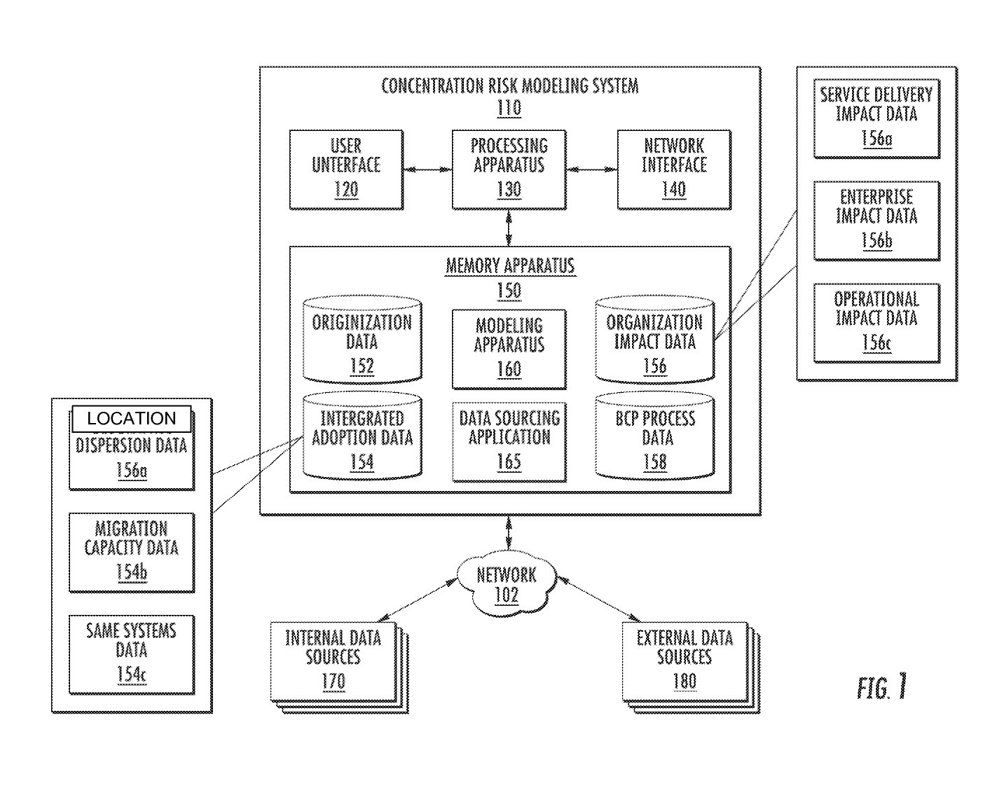

FIG. 1 provides a block diagram of a concentration-risk modeling environment 100, in accordance with one embodiment of the present disclosure. The concentration-risk modeling environment 100 generally includes a concentration-risk modeling system 110 in communication with one or more internal data sources 170 and one or more external data sources 180 via a network 102. The concentration-risk modeling system 110 comprises a user-interface apparatus 120, a network-interface apparatus 140, and a memory apparatus 150 operatively coupled to a processing apparatus 130. As described in greater detail below, embodiments of the concentration-risk modeling system 110 are generally configured to model concentration risks within an organization's footprint. In this regard, in some embodiments of the disclosure, the concentration-risk modeling system 110 is owned or maintained or operated by an organization having a footprint that extends to multiple locations, and the concentration-risk modeling system 110 may, in some embodiments, be integrated with other systems of such organization and may share at least some hardware, software, and/or other resources with such other systems. It should also be appreciated that the concentration-risk modeling system 110 may be owned or maintained or operated by a third party that provides concentration-risk information to the organization.

As used herein, the term “apparatus” refers to a device or a combination of devices having the hardware and/or software configured to perform one or more specified functions. Therefore, an apparatus is not necessarily a single device and may, instead, include a plurality of devices that make up the apparatus. The plurality of devices may be directly coupled to one another or may be remote from one another, such as distributed over a network. As used herein, the term “organization” refers to any business or non-business entity that has multiple employees performing multiple processes in multiple centers. As used herein, the term “center” refers to a physical location where an organization's employees perform certain processes in furtherance of the organization's operation. The term location may refer to a street address, particular building or portion of a building (e.g., office, suite, floor, etc.), city, state, and the like.

It will be understood by one of ordinary skill in the art that, although FIG. 1 illustrates the user interface 120, network interface 140, memory apparatus 150, and processing apparatus 130 as separate blocks in the block diagram, these separations may be merely conceptual. In other words, in some instances, the user interface 120, for example, is a separate and distinct device from the processing apparatus 130 and the memory apparatus 150 and therefore may have its own processor, memory, and software. In other instances, however, the user interface 120 is directly coupled to or integral with at least one part of the processing apparatus 130 and at least one part of the memory apparatus 150 and includes the user interface input and output hardware used by the processing apparatus 130 when the processing apparatus 130 executes user input and output software stored in the memory apparatus 150.

As will be described in greater detail below, in one embodiment, the concentration-risk modeling system 110 is entirely contained within a user terminal, such as a personal computer or mobile terminal, while, in other embodiments, the concentration-risk modeling system 110 includes a central computing system, one or more network servers, and one or more user terminals in communication with the central computing system via a network and the one or more network servers. FIG. 1 is intended to cover both types of configurations as well as other configurations that will be apparent to one of ordinary skill in the art in view of this disclosure.

The user interface 120 includes hardware and/or software for receiving input into the concentration-risk modeling system 110 from a user and hardware and/or software for communicating output from the concentration-risk modeling system 110 to a user. In some embodiments, the user interface 120 includes one or more user input devices, such as a keyboard, keypad, mouse, microphone, touch screen, touch pad, controller, and/or the like. In some embodiments, the user interface 120 includes one or more user output devices, such as a display (e.g., a monitor, liquid crystal display, one or more light emitting diodes, etc.), a speaker, a tactile output device, a printer, and/or other sensory devices that can be used to communicate information to a person. In one embodiment, the user interface 120 includes a user terminal, which terminal may be used by an employee of an organization owning or leasing commercial real estate to house its workforce.

In some embodiments, the network interface 140 is configured to receive electronic input from other devices in the network 102, including the internal data sources 170 and the external data sources 180. In some embodiments, the network interface 140 is further configured to send electronic output to other devices in a network. The network 102 may include a direct connection between a plurality of devices, a global area network such as the Internet, a wide area network such as an intranet, a local area network, a wireline network, a wireless network, a virtual private network, other types of networks, and/or a combination of the foregoing.

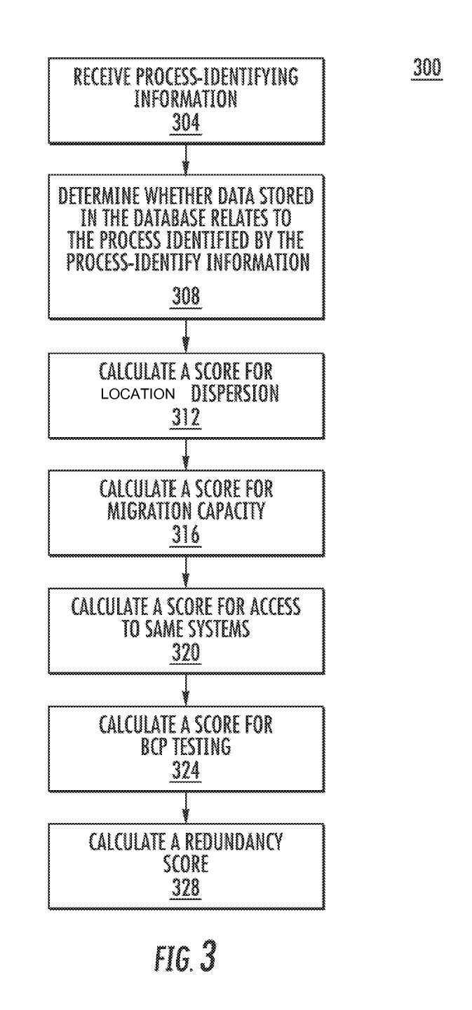

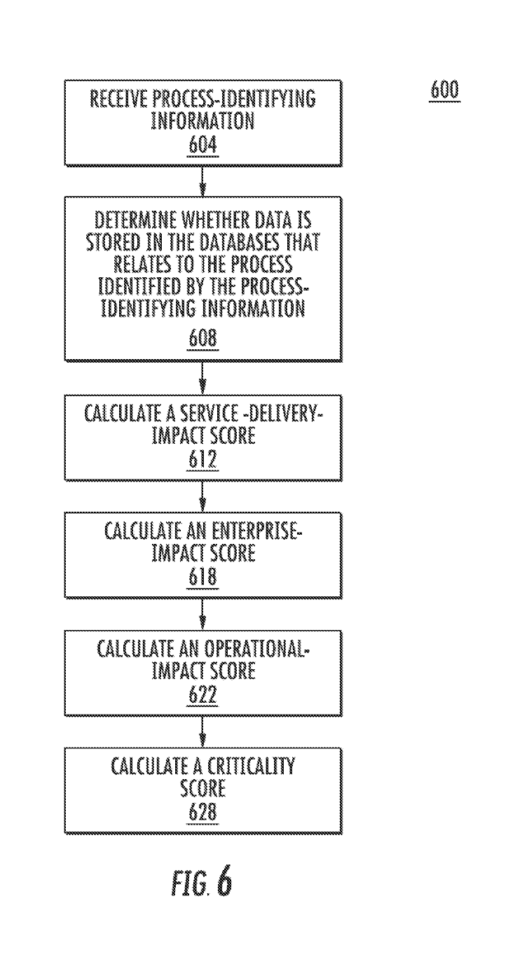

The processing apparatus 130 includes circuitry used for implementing communication and logic functions of the concentration-risk modeling system 110. For example, the processing apparatus 130 may include a digital signal processor device, a microprocessor device, and various analog-to-digital converters, digital-to-analog converters, and other support circuits. Control and signal processing functions of the concentration-risk modeling system 110 are allocated between these devices according to their respective capabilities. The processing apparatus 130 may include functionality to operate one or more software programs based on computer-readable instructions thereof, which may be stored in the memory apparatus 150. As described in greater detail below, in one embodiment of the disclosure, the memory apparatus 150 includes a modeling application 160 and a data-sourcing application 165 stored therein for instructing the processing apparatus 140 to perform one or more operations of the procedures described herein and in reference to FIGS. 3 and 6. Some embodiments of the disclosure may include other computer programs stored in the memory apparatus 150.

In general, the memory apparatus 150 is communicatively coupled to the processing apparatus 130 and includes computer-readable storage medium for storing computer-readable program code and instructions, as well as datastores containing data and/or databases. More particularly, the memory apparatus 150 may include volatile memory, such as volatile Random Access Memory (RAM) including a cache area for the temporary storage of data. The memory apparatus 150 may also include non-volatile memory that can be embedded and/or may be removable. The non-volatile memory can, for example, comprise an EEPROM, flash memory, or the like. The memory apparatus 150 can store any of a number of pieces of information and data used by the concentration-risk modeling system 110 to implement the functions of the concentration-risk modeling system 110 described herein.

In the illustrated embodiment, the memory apparatus 150 includes datastores containing general organization data 152, integrated-adoption data 154, criticality-to-organization data 156, and business-continuity-planning (BCP) process data 158. According to some embodiments, the general organization data 152 includes general information about the organization. In some embodiments, the general organization data 152 includes information about each of the organization's centers. For example, for each center, the general organization data 152 includes the center's identification, the center's address, building information about the center, the number of employees at the center, a description of each of the processes performed at the center, a description of which processes the center is capable of performing, the number of employees assigned to each of the respective processes, a description of the center's delivery systems, e.g., computer programs and networks, and other information related to the center.

In some embodiments, the general organization data 152 also includes data about each of the employees of the organization. Linkages may be provided between the employees and the centers such that the data for those employees working in a particular center is linked to the data for that center. The data about each employee may include identification information, indications of which center the employee is assigned to, indications of the line of business and/or job functions of the employee, indications of which processes the employee is involved in executing, indications of which delivery systems the employee uses, and indications of whether the employee is a contractor or an actual employee of the organization. The general organization data 152 may be received from a user via the user interface 120, or may be obtained through electronic communication with another device, such as the internal data sources 170 or the external data sources 180, via the network 102 and utilizing the network interface 140, and then stored in the memory apparatus 150.

According to some embodiments, the integrated-adoption data 154 includes information about the organization's processes and the redundancy of those processes. As used herein, the term “redundancy” refers to an organization's capacity to move work from one center to another center in the event of disruption in one of the centers. For example, in some embodiments, redundancy refers to whether and how quickly a process can be moved from one center to another center. In an embodiment, the integrated-adoption data 154 includes general information about each process within the organization. For example, for each process, integrated-adoption data 154 includes the name of the process, the identification number/code for the process, a description of the process, information about each of the employees assigned to the process, and the manager in charge of the process. The integrated-adoption data 154 includes further information about the processes. This further information is divided into three groups: location-dispersion data 154a; migration-capacity data 154b; and access-to-same systems data 154c. Each of the three groups will be discussed in turn below.

According to some embodiments, location-dispersion data 154a includes data about the location dispersion of the organization's processes. For each process, the location-dispersion data 154a includes the number of centers and the location of each center where the process is executed or capable of being executed. For example, information about the location of a center includes city and address information as well as specific building information. Also, for each process, the location-dispersion data 154a includes information about how many employees are in a particular center executing that process. Linkages may be provided between the employees, the processes, and the centers such that the data for those employees and centers associated with a particular process is linked to the location-dispersion data for that process.

According to some embodiments, migration-capacity data 154b includes information about the distribution across the various centers of: (1) the volume of work for a particular process; and (2) the number of employees that work on a particular process. For each process, migration-capacity data 154b lists each center where work on that process is done. For each listed center, migration-capacity data 154b includes: (1) the percentage of the overall volume of work for that process that is done at that center; and (2) the percentage of the total number of employees that work on that process that are located at that center. For example, work on a particular process may be distributed across multiple centers located in different cities, but if most of the work is being done in one center, then there may be an over-concentration in that center. Accordingly, for each process, migration-capacity data 154b details the distribution across the various centers of the volume of work and number of employees doing the work. Linkages may be provided between employees, processes, and centers such that the data for those employees, processes and centers can be linked to the migration-capacity data.

According to some embodiments, access-to-same-systems data 154c includes information about whether the systems of one center are compatible with systems of another center and whether work from the systems of one center can be transferred to the systems of another center. For example, access-to-same-systems data 154c includes information that indicates whether employees in different centers have access to the same systems and whether employees are trained to work off of the same systems to move work from one center to another center. Access-to-same-systems data 154c includes information that indicates the number of employees that work on the same process and that have access to the same systems. Further, access to same systems data 154c includes information that indicates the total volume of work that is done for a process using the same system. Linkages may be provided between employees, processes, centers, and systems such that the data for those employees, processes, centers, and systems can be linked to access-to-same systems data.

The integrated-adoption data 154 may be received from a user via the user interface 120, or may be obtained through electronic communication with another device, such as the internal data sources 170 or the external data sources 180, via the network 102 and utilizing the network interface 140, and then stored in the memory apparatus 150.

Turning now to the criticality-to-organization data 156. According to some embodiments, the criticality-to-organization data 156 includes information about the criticality of each of the organization's processes. As used herein, the term “criticality” refers to how important a particular process is to the organization. In an embodiment, the criticality-to-organization data 156 is divided into three groups: service delivery-impact data 156a; enterprise-impact data 156b; and operational-impact data 156c. Each of the three groups will be discussed in turn below.

Service-delivery-impact data 156a includes information for each process that indicates the customer impact that would result from a failure of that process. For example, service-delivery-impact data 156a includes information for each process that indicates whether failure of that process will result in customers being denied access to the organization's products and services. For example, service-delivery-impact data 156a also includes information that indicates customer demand for each process and/or customer demand for products and services that result from each process. According to some embodiments, service-delivery-impact data 156a further includes information that indicates the uniqueness and/or customization of each process. If a process is not particularly unique or customized and can be replaced by other, similar processes, then that process has a relative low criticality score. However, if a process is particularly unique and/or customized and cannot be easily replaced by other processes, then the process has a relatively high criticality score. For example, service-delivery-impact data 156a also includes, for each process, information that indicates whether the failure of the process will result in the organization's failure to timely meet customer-imposed deadlines.

Enterprise-impact data 156b includes information, for each process, that indicates the impact on the organization as a whole if the process were interrupted. For example, some processes may be interrupted, but the organization would not feel much impact and the organization's operational continuity would not be significantly affected. However, interruption of some processes would result in severe impact on the organization. For example, some processes are important to multiple aspects of the organization as a whole, and, if one of those important processes were interrupted, the entire organization would be disrupted.

For example, enterprise-impact data 156b includes financial-risk data, which includes information for each process that estimates the economic impact that would result from a failure of that process. In some embodiments, for each process, financial-risk data includes information that indicates the opportunity costs, such as lost revenue, that would result from the failure of that process. Also, for example, financial-risk data includes information that indicates customer demand for each process and/or customer demand for products and services that result for a particular process. This information may also include revenue and profit information associated with products and processes that may be affected by disruption of a particular process. Further, for example, this information includes data that indicates the extent to which delivery of products and services would be affected by failure of the process. According to some embodiments, like the data described above with respect to service-delivery-impact data, financial-risk data may include information that indicates the uniqueness of each process. If a process is not particularly unique and can be replaced by other, similar process, then failure of that process will likely not result in substantial economic impact and, accordingly, that process has a relative low financial risk. However, if a process is particularly unique and cannot be easily replaced by other processes, then the process has a relatively high financial risk.

Also, for example, enterprise-impact data 156b includes regulatory-risk data, which includes information regarding whether there are any legal obligations to continue a particular process. For example, regulatory-risk data includes information regarding whether the organization would violate a law, rule, or regulation if the organizational allows a disruption to one of its processes, such compliance processes that drive SEC or tax filings. Regulatory-risk data also includes any fines that may result from the violation of any law, rule, or regulation.

Also, for example, enterprise-impact data 156b includes reputation-risk data, which includes information that indicates the reputational impact on the organization that would result from the failure of a particular process.

The criticality-to-organization data 156 may be received from a user via the user interface 120, or may be obtained through electronic communication with another device, such as the internal data sources 170 or the external data sources 180, via the network 102 and utilizing the network interface 140, and then stored in the memory apparatus 150.

Operational-impact data 156c includes information, for each process, that indicates the impact on the organization's operational continuity if the process fails. Operational-impact data 156c includes information that indicates how dependent the organization is on the process. For example, some processes are important to multiple aspects of the organization as a whole, and, if one of those important processes failed, the organization's operational continuity would be disrupted, thereby resulting in financial harm to the organization. However, other processes may fail, but the organization would not feel much of an impact and the organization's operational continuity would not be affected because these processes are not important to multiple aspects of the organization. For example, operational-impact data 156c indicates how many and which subdivisions within the organization are dependent on a particular process. If multiple subdivisions within the organization dependent on a particular process, then that process has a relatively high criticality score because the operation of the organization would be impaired if that process failed. For example, processes are often highly critical if their failure would impact equipment, facilities, suppliers, and/or employees that are instrumental to the organization's operational continuity.

Turning now to the BCP process data 158, by way of background, a typical BCP report details procedures for moving work from one center to another center in the event one of the centers experiences a disruption. Typical BCP reports also provide a time-estimate for completing the work migration. For example, a BCP report for a particular process may indicate that the process can be recovered by a backup center in one hour. In this case, for example, suppose a process is performed in two centers, one in the city of Charlotte and the other in the city of New York. Each center serves as a backup for the other. If either the center in New York or the center in Charlotte experiences a disruption, then the other center can pick up the disrupted center's work within an hour.

With that information about BCP reports as background, according to some embodiments, the BCP process data 158 includes information that indicates when each of the organization's processes was last tested for BCP. For example, according to an embodiment, the BCP process data 158, for each process, indicates whether BCP testing has occurred and, if BCP testing has occurred, the last time it occurred. According to other embodiments, the BCP process data 158, for each process, indicates whether a BCP testing has occurred within the last year.

The BCP process data 158 may be received from a user via the user interface 120, or may be obtained through electronic communication with another device, such as the internal data sources 170 or the external data sources 180, via the network 102 and utilizing the network interface 140, and then stored in the memory apparatus 150.

For the sake of clarity and ease of description, the figures provided herein generally illustrate the general organization data 152, the integrated-adoption data 154, the criticality-to-organization data 156, and the BCP process data 158 as each being separate from one another. However, it will be understood that, in some embodiments, these datastores may be combined or the data described as being stored within such datastores may be further separated into additional datastores. For example, in some embodiments, the general organization data 152 includes the integrated-adoption data 154 to combine data about the organization's processes with the general organizational data contained in the general organization data 152 Likewise, the general organization data 152 may include criticality-to-organization data 156 and/or BCP process data 158.

In one embodiment, data within each of the four datastores shown in FIG. 1 may be linked to, and thus organized around, a process identification stored in the memory apparatus 150. In such case, unique-process identifications are assigned to each of the organization's processes. Thus, each unique-process identification is linked within the memory apparatus 150 to: (1) general data within the general organization data 152 relating to each of the centers where the process is executed; (2) process data relating to the process itself within the integrated-adoption data 154; (3) impact data relating to the process within the criticality-to-organization data 156; and (4) BCP process data relating to the process within the BCP process data 158. The unique-process identifications may be input by the user via the user interface 120, and may be stored by the processing apparatus 130 in any of the four datastores or in a separate datastore within the memory apparatus 150. Furthermore, the user may also create linkages in the memory device 150 between the unique-process identifications and the data within the four datastores utilizing the user interface 120, as described in detail below.

As further illustrated by FIG. 1, the memory apparatus 150 also includes a modeling application 160 and a data-sourcing application 165. As used herein, the term “application” generally refers to computer-readable program code comprising computer-readable instructions and stored on a computer-readable storage medium, where the instructions instruct a processor to perform certain functions, such as logic functions, read and write functions, and/or the like. In this regard, each of the modeling application 160 and data-sourcing application 165 includes computer-readable instructions for instructing the processing apparatus 130 and/or other devices to perform one or more of the functions described herein, such as one or more of the functions described in FIGS. 3 and 6. While the modeling application 160 and data-sourcing application 165 are drawn as separate applications within the memory apparatus 150, it should be understood that the functions of the two applications as described herein could be ascribed to a single application or more than two applications.

FIG. 1 further provides one or more internal data sources 170 and one or more external data sources 180 in communication with the concentration-risk modeling system 110 via the network 102. In some embodiments, the internal data sources 170 are databases within the network of computer systems of the organization under review and/or the entity utilizing the concentration-risk modeling system 110 to model concentration risk. The internal data sources 170 may contain data relevant to the organization's processes, employees, and/or centers. In some embodiments, the internal data sources 170 may be certain databases maintained by the organization under review. The external data sources 180 likewise contain data relevant to the organization's processes, employees, and/or centers, however, the external data sources 180 are not located within the network of computer systems of the organization and/or the entity utilizing the concentration-risk modeling system 110 to model concentration risk. In some embodiments, the external data sources 180 provide, for example, data relating to the organization's suppliers and/or contractors. In some embodiments, both the internal data sources 170 and the external data sources 180 supply data to be relied upon by the concentration-risk modeling system 110 in order to carry out the various processes described herein.

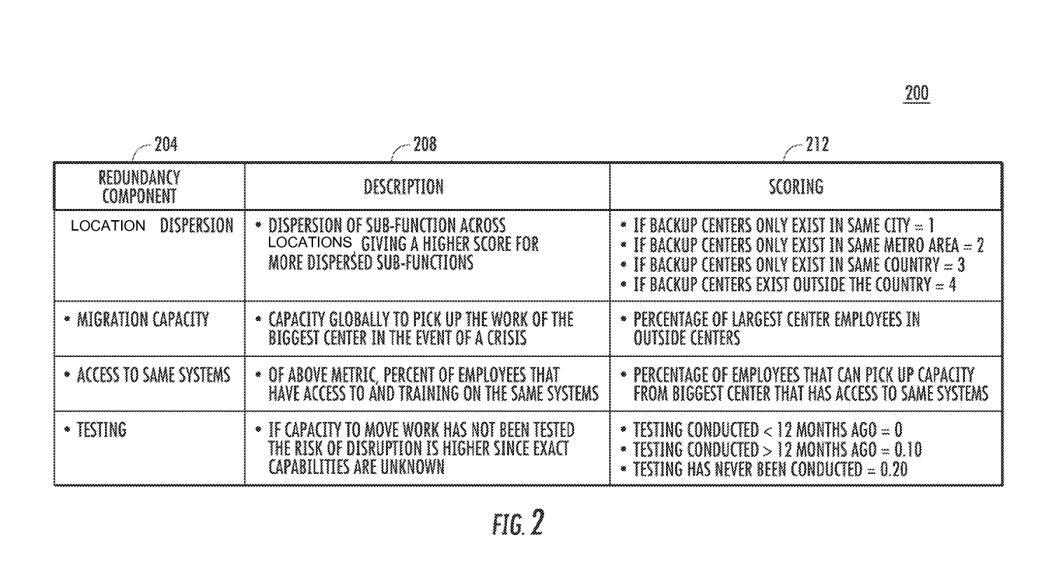

With reference to FIGS. 2-4, redundancy and one example process of calculating redundancy scores will be described in more detail. As mentioned above, the term “redundancy” refers to an organization's capacity to move work from one center to another center in the event of a disruption in one of the centers. For example, in the context of embodiments of the present disclosure, redundancy refers to the organization's ability to move work on a particular process from a primary center to a backup center in the event the primary center is disrupted. Embodiments of the disclosure calculate a redundancy score for the organization. This redundancy score reflects the organization's ability to move process work from one center to another. Further, this redundancy score is combined with a criticality score to calculate an overall concentration score. Criticality scores and overall concentrations as well as methods for calculating them are described in more detail further below.

According to an embodiment, redundancy scores are calculated using integrated-adoption data 154. For illustrative convenience, column 204 of table 200 in FIG. 2 lists four exemplary redundancy components on which redundancy scores may be based. Column 208 provides a brief description of each of the exemplary redundancy components, and column 212 provides exemplary scoring criteria for each of the redundancy components. It should be appreciated that the exemplary redundancy components of column 204 and the scoring criteria of column 212 are provided for illustrative purposes and that those skilled in the art will recognize that myriad other components and scoring criteria may be used to calculate redundancy.

FIG. 3 provides a flow diagram illustrating a process 300 whereby an organization utilizes the concentration-risk modeling system 100 of the present disclosure to calculate a redundancy score for a process within the organization that is under review, in accordance with an embodiment of the present disclosure. While the process 300 illustrated by the flow diagram of FIG. 3 is described in the context of a single process within the organization, it should be understood that the concentration-risk modeling system 110 is configured to manage the modeling and analysis of the entire organization, and the process 300 can therefore be employed by an organization to calculate a redundancy score for all of the organization's processes.

Referring to FIG. 3, as represented by block 304, according to some embodiments, the concentration-risk modeling system 100 receives process-identifying information via the user interface 120 for a particular process for which the organization wishes to calculate a redundancy score. In such instances, the modeling application 160 instructs the processing apparatus 130 to receive the process-identifying information via the user interface 120. As represented by decision block 308, once the process-identifying information has been received by the processing apparatus 130, the modeling application 160 determines whether data is stored in the datastores of the memory apparatus 150 that relates to the particular process identified by the process-identifying information. In particular, the modeling application 160 instructs the processing apparatus 130 to determine whether any of the data within the datastores of the memory apparatus 150 contain data pertaining to the identified process.

In the event information is located in the memory apparatus 150 by the processing apparatus 130 that is associated with process, then, as represented by block 312, the modeling application 160 instructs the processing apparatus 130 to calculate a score for location dispersion. To do so, the modeling application 160 instructs the processing apparatus 130 to access the memory apparatus 150 and locate the location-dispersion data 154a of the integrated-adoption data 154 for the particular process. With reference to the exemplary scoring criteria of column 212 of FIG. 2, an exemplary scoring methodology will now be provided. Once the location-dispersion data 154a has been located, the modeling application 160 instructs the processing apparatus 130 to review the data and determine whether the backup centers for the process exist: only in the same city as the primary center, e.g., the center having the largest number of employees; only in the same area as the primary center; only in the same state or country as the primary center; or outside of the state or country where the primary center is located. Once this determination is made, the modeling application 160 instructs the processing apparatus 130 to assign a location-dispersion score of: one if the backup centers for the process exist only in the same city as the primary center; two if the backup centers for the process exist only in the same area as the primary center; three if the backup centers for the process exist only in the same state or country as the primary center; or four if the backup centers for the process exist outside of the state or country where the primary center is located.

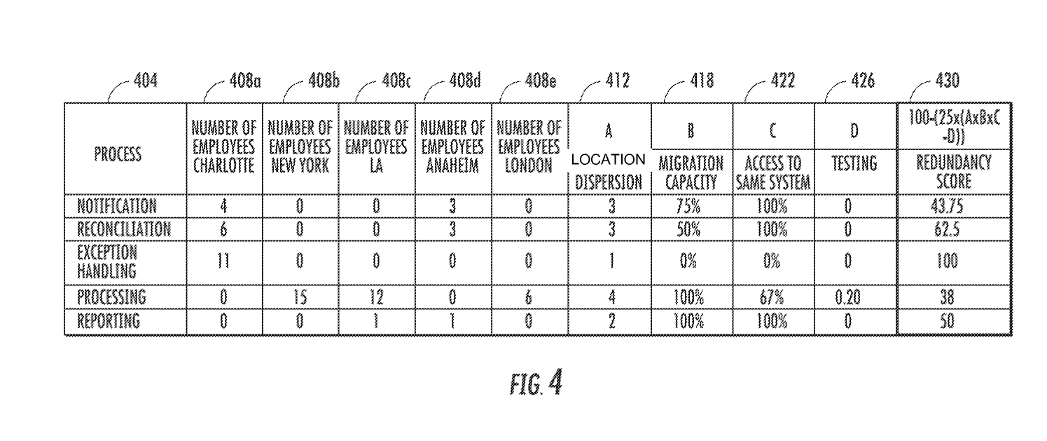

Referring now to FIG. 4, an exemplary redundancy-score table 400 is provided for illustrative convenience. Column 404 lists five exemplary processes within an organization. Columns 408a-e provide the number of employees in five different cities that are assigned to work on the five processes of column 404. For example, the organization has four employees in Charlotte and three employees in Anaheim that work on the process of notification. Also, for example, the organization has fifteen employees in New York, twelve in Los Angeles, and six in London that work on the process of processing. Column 412 lists the location-dispersion score for each of the processes listed in column 404. For example, the process of notification has a location-dispersion score of three because backup centers only exist in the same country. More specifically, Charlotte has four employees that backup three employees in Anaheim. Likewise, the employees in Anaheim backup the employees in Charlotte. Continuing with the process of notification example, if there were employees in London who were assigned to the process of notification, then the process of notification would have a location dispersion score of four because the London backup center for the process is outside of the country where the primary Charlotte center is located. Further continuing with the process of notification example, if the four Charlotte employees were relocated to Los Angeles, the location-dispersion score for notification would be three because the backup centers would exist only in the same metro area. Continuing with the process of notification, if the all of the employees were located in either Anaheim or Charlotte, then the process of notification would have a location-dispersion score of one.

After the location-dispersion score has been calculated, the modeling application 160 instructs the processing apparatus 130 to calculate a score for migration capacity, as represented by block 316. To do so, the modeling application 160 instructs the processing apparatus 130 to access the memory apparatus 150 and locate the migration-capacity data 154b of the integrated-adoption data 154 for the particular process. With reference to the exemplary scoring criteria of column 212 of FIG. 2, an exemplary scoring system for migration capacity will now be provided. Once the migration-capacity data 154b has been located, the modeling application 160 instructs the processing apparatus 130 to identify the center having the largest number of employees; aggregate the number of employees that work on that process but do not work in the largest center; and calculate the ratio that compares the number of employees that do not work in the largest center to the number of employees that work in the largest center. This ratio represents the percentage of the largest center's work that can be migrated to the other centers in the event the largest center is disrupted.

Examples of calculating migration-capacity scores will now be provided with reference to the exemplary-redundancy score table 400 of FIG. 4. Column 418 lists the migration-capacity score for each of the processes listed in column 404. As mentioned above, in this example, the organization has four employees in Charlotte and three employees in Anaheim that work on the process of notification. To calculate migration capacity for this process, Charlotte, which has four employees, would be identified as the largest center because it has the most employees. The aggregated number of employees that do not work in Charlotte is three. The ratio comparing the number of employees that do not work in Charlotte to the number of employees that do work in Charlotte is three to four. Accordingly, the migration-capacity score for the process of notification is 75%. This means if Charlotte experiences a disruption, then 75% of Charlotte's work can be migrated to Anaheim.

Also, for example, to calculate the migration capacity of the reconciliation process, Charlotte, which has six employees, would be identified as the center having the most employees. The aggregated number of employees that do not work in Charlotte is three. The ratio comparing the number of employees that do not work in Charlotte to the number of employees that do work in Charlotte is three to six. Accordingly, the migration capacity for the reconciliation process is 50%. This means that if the center in Charlotte experiences a disruption, then 50% of Charlotte's work can be migrated to Anaheim.

Further, for example, to calculate the migration capacity for the process of processing, New York, which has fifteen employees, would be designated as the center having the most employees. The aggregated number of employees that do not work in New York is eighteen (twelve in Los Angeles plus six in London). Accordingly, the ratio that compares the number of employees that do not work in New York to the number of employees that do work in New York is eighteen to sixteen. Accordingly, the migration capacity of the process of processing is 100% because all of New York's work can be migrated to Los Angeles and London in the event New York is disrupted.

After the migration-capacity score has been calculated, the modeling application 160 instructs the processing apparatus 130 to calculate a score for access to same systems, as represented by block 320. To do so, the modeling application 160 instructs the processing apparatus 130 to access the memory apparatus 150 and locate the access-to-same-systems data 154c of the integrated-adoption data 154 for the particular process. With reference to the exemplary scoring criteria of column 212 of FIG. 2, an exemplary methodology for scoring access to same systems will now be provided. Once the access-to-same-systems data 154c has been located, the modeling application 160 instructs the processing apparatus 130 to identify the largest center, which is the center that has the largest number of employees; aggregate the number of employees that do not work in the largest center; aggregate the number of employees that do not work in the largest center but have access to the same systems that the largest center uses; and then, of employees that do not work in the largest center, calculate the percentage of employees that have access to the same systems that the largest center uses.

Examples of calculating access-to-same-systems scores will now provided with reference to the exemplary redundancy-score table 400 of FIG. 4. Column 422 lists the access-to-same-system score for each of the processes listed in column 404. For example, to calculate the score for access to same systems for the process of processing, New York, which has fifteen employees, would be identified as the largest center because it has the most employees. The aggregated number of employees that do not work in New York is eighteen (twelve in Los Angeles and six in London). Further, the aggregated number of employees that do not work in New York but have access to the same systems as New York is twelve because, although not indicated in table 400, only the twelve employees in Los Angeles have access to the same systems as New York. The six employees in London use a different system. Accordingly, of the employees that do not work in New York, twelve out of eighteen have access to the same systems as New York. Accordingly, the access-to-same-systems score for the process of processing is 67%.

After the access-to-same-system score has been calculated, the modeling application 160 instructs the processing apparatus 130 to calculate a score for BCP processing, as represented by block 324. To do so, the modeling application 160 instructs the processing apparatus 130 to access the memory apparatus 150 and locate the BCP processing data 158 for the particular process. With reference to the exemplary scoring criteria of column 212 of FIG. 2, an exemplary methodology for scoring BCP testing will now be provided.

Once the BCP processing data 158 has been located, the modeling application 160 instructs the processing apparatus 130 to determine whether BCP testing has ever been conducted. If testing has been conducted, then the modeling application 160 instructs the processing apparatus 130 to determine whether BCP testing was conducted within a year of the inquiry date. According to an embodiment, if BCP testing has never been conducted, then the BCP testing score is 0.20. If BCP testing was conducted more than one year prior to the inquiry date, then the BCP testing score is 0.10. If BCP testing was conducted within a year of the inquiry data, then the BCP testing score is 0.00. A BCP testing score for each of the processes listed in column 404 of table 400 is provided in column 426. From table 400, one can see that BCP testing has never been conducted for the process of processing, but BCP testing has been conducted within the last year for all other processes.

After each of the location-dispersion, migration-capacity, access-to-same-systems, and BCP testing scores have been determined, the modeling application 160 instructs the processing apparatus 130 to input the respective scores in to a redundancy equation to calculate the redundancy score for the particular process under review, as represented by block 328. According to an embodiment, the modeling application 160 instructs the processing apparatus 130 inputs the respective scores into the exemplary redundancy equation provided in column 430 of table 400, where A is the location-dispersion score, B is migration-capacity score, C is the access-to-same systems score, and D is the BCP testing score.

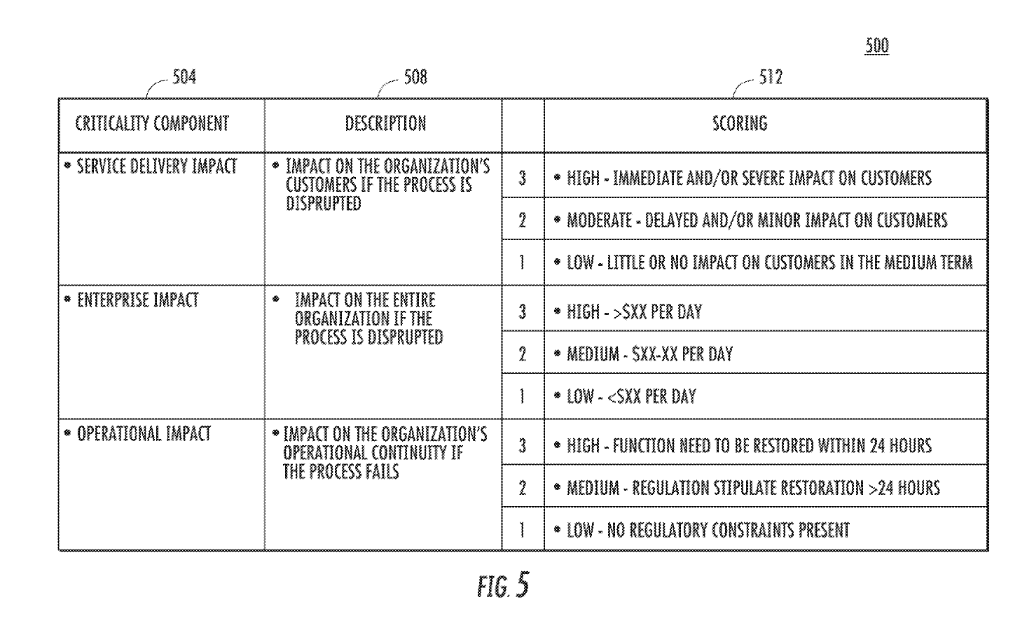

With reference to FIGS. 5-8, criticality and the process of calculating criticality scores will be described in more detail. As mentioned above, the term “criticality” refers to how important a particular process is to the organization. For example, in the context of embodiments of the present disclosure, criticality considers the impact on the organization's customers if a particular process is disrupted, the impact on the organization as a whole if a particular process is disrupted, and the impact on the organization's operational continuity if a particular process is disrupted. As described in more detail below, after calculating a criticality score for a particular process, embodiments of the present disclosure combine the criticality score with the redundancy score for that process in order to calculate an overall concentration-risk score for that process.

According to an embodiment, criticality scores are calculated based on three criticality components: service-delivery impact; enterprise impact; and operational impact. For illustrative convenience, column 504 of table 500 in FIG. 5 lists the three exemplary criticality components. Column 508 provides a brief exemplary description of each of the three exemplary criticality components, and column 512 provides exemplary scoring criteria for each of the three criticality components. It should be appreciated that the criticality components of claim 504 and the scoring criteria of column 512 are provided for illustrative purposes and that those skilled in the art will recognize that myriad other criticality components and scoring criteria may be used.

FIG. 6 provides a flow diagram illustrating a process 600 whereby an organization utilizes the concentration-risk modeling system 100 of the present disclosure to calculate a criticality score for a particular process within the organization that is under review, in accordance with an embodiment of the present disclosure. While the process 600 illustrated by the flow diagram of FIG. 6 is described in the context of a single process within the organization, it should be understood that the concentration-risk modeling system 110 is configured to manage the modeling and analysis of the entire organization, and the process 600 can therefore be employed by an organization to calculate a criticality score for all of the organization's processes.

Referring to FIG. 6, as represented by block 604, according to some embodiments, the concentration-risk modeling system 100 receives process-identifying information via the user interface 120 for a particular process for which the organization wishes to calculate a criticality score. In such instances, the modeling application 160 instructs the processing apparatus 130 to receive the process-identifying information via the user interface 120. As represented by decision block 608, once the process-identifying information has been received by the processing apparatus 130, the modeling application 160 determines whether data is stored in the datastores of the memory apparatus 150 that relates to the particular process identified by the process-identifying information. In particular, the modeling application 160 instructs the processing apparatus 130 to determine whether any of the data within the datastores of the memory apparatus 150 contain data pertaining to the identified process.

In the event information is located in the memory apparatus 150 by the processing apparatus 130 that is associated with process, then, as represented by block 612, the modeling application 160 instructs the processing apparatus 130 to calculate a service-delivery-impact score. To do so, the modeling application 160 instructs the processing apparatus 130 to access the memory apparatus 150 and locate the service-delivery-impact data 156a of the criticality-to-organization data 156 for the particular process. With reference to the exemplary scoring criteria of column 512 of FIG. 5, an exemplary scoring methodology will now be provided. Once the service-delivery-impact data 156a has been located, the modeling application 160 instructs the processing apparatus 130 to review the data and determine whether disruption of the process would result in: little or no impact on customers in the medium term; delayed and/or minor impact on customers; or immediate and/or severe impact on customers.

Once this determination is made, the modeling application 160 instructs the processing apparatus 130 to assign a service-delivery-impact score of: one if disruption of the process would result in little or no impact on customers in the medium term; two if disruption of the process would result in delayed and/or minor impact on customers; or three if disruption of the process would result in immediate and/or severe impact on customers.

After the service-delivery-impact score has been determined for the process, as represented by block 618, the modeling application 160 instructs the processing apparatus 130 to calculate an enterprise-impact score. To do so, the modeling application 160 instructs the processing apparatus 130 to access the memory apparatus 150 and locate the enterprise-impact data 156b of the criticality-to-organization data 156 for the particular process. With reference to the exemplary scoring criteria of column 512 of FIG. 5, an exemplary scoring methodology will now be provided. Once the enterprise-impact data 156b has been located, the modeling application 160 instructs the processing apparatus 130 to review the data and determine the amount of money that the organization will lose per day as result of the process being disrupted.

Once this determination is made, the modeling application 160 instructs the processing apparatus 130 to assign an enterprise-impact score of one, two, or three depending on the exemplary scoring criteria provided for enterprise impact. It should be appreciated that the scoring criteria is set by the organization's decision-makers. For example, for low risk, the decision-makers select a low-risk value that reflects the maximum amount of money that the organization can afford to lose per day with minimum impact on the organization as a whole. For medium risk, the decision-makers select a medium-risk value range that reflects the amount of money that the organization can afford to lose per day with medium impact on the organization as a whole. For high risk, the decision-makers select a high-risk value that reflects the minimum amount of money lost per day that would highly impact the organization as a whole.

If it is determined the amount of money that the organization will lose per day is equal to or less than the low-risk value, then the modeling application 160 instructs the processing apparatus 130 to assign the process a enterprise-impact score of one. If it is determined the amount of money that the organization will lose per day is within the medium-risk value range, then the modeling application 160 instructs the processing apparatus 130 to assign the process a enterprise-impact score of two. If it is determined the amount of money that the organization will lose per day is equal to or higher than the high-risk value, then the modeling application 160 instructs the processing apparatus 130 to assign the process a enterprise-impact score of three.

After the service-delivery-impact score has been determined for the process, as represented by block 622, the modeling application 160 instructs the processing apparatus 130 to calculate an operational-impact score. To do so, the modeling application 160 instructs the processing apparatus 130 to access the memory apparatus 150 and locate the operational-impact data 156c of the criticality-to-organization data 156 for the particular process. With reference to the exemplary scoring criteria of column 512 of FIG. 5, an exemplary scoring methodology will now be provided. Once the operational-impact data 156c has been located, the modeling application 160 instructs the processing apparatus 130 to review the data and determine whether, according to the organization's decision-maker and/or compliance regulations, the process, if disrupted, would: not need to be restored; need to be restored but not necessarily within twenty-four hours; or need to be restored within twenty-four hours.

Once this determination is made, the modeling application 160 instructs the processing apparatus 130 to assign an operational-impact score of: one if the process would not need to be restored; two if the process would need to be restored but not within twenty-four hours; or three if the process would need to be restored within twenty-four hours.

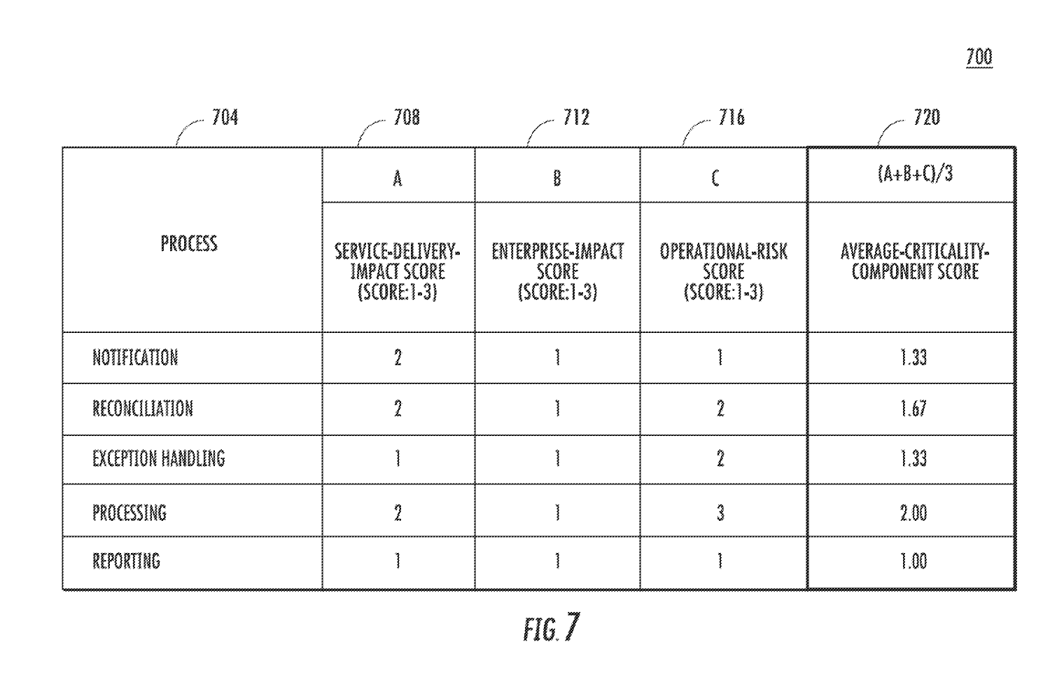

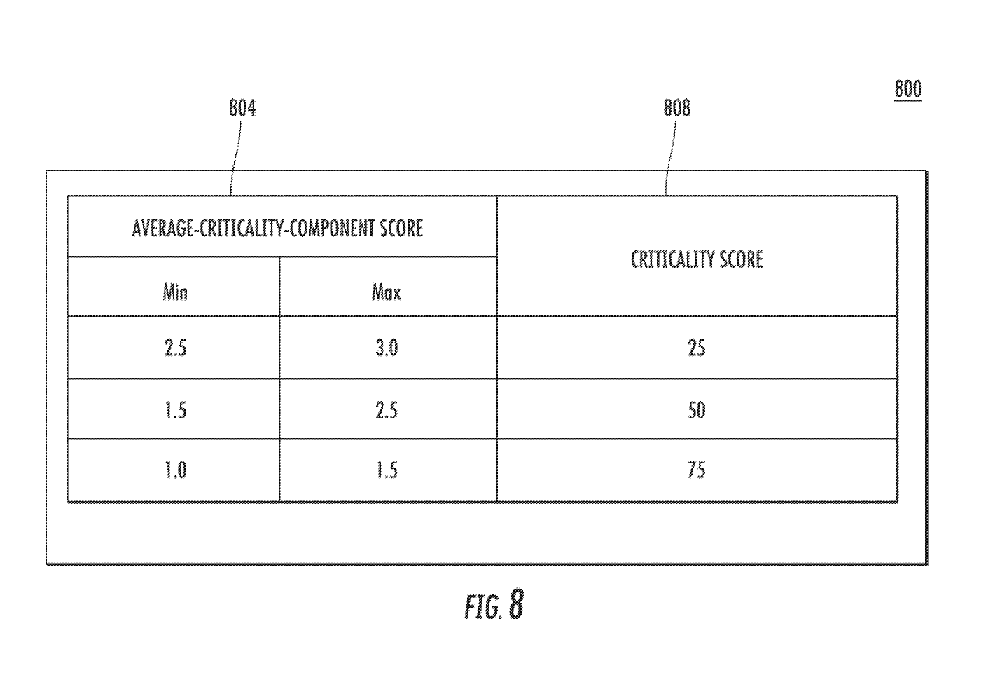

After each of the service-delivery-impact, enterprise-impact, and operational-impact scores have been determined, the modeling application 160 instructs the processing apparatus 130 to calculate the criticality score for the particular process under review, as represented by block 428. Determining the criticality score will be discussed with references to FIGS. 7 and 8. Referring now to FIG. 7, an exemplary criticality-component-score table 700 is provided. Column 704 lists the same five exemplary processes within an organization at are listed in FIG. 4. Column 708 lists the service-delivery-impact score for each of the processes listed in column 704, column 712 lists the enterprise-impact score for each of the processes listed in column 704, and column 716 lists the operational-impact score for each of the processes listed in column 704.

According to an embodiment, the modeling application 160 instructs the processing apparatus 130 to determine an average-criticality-component score for each of the processes listed in column 704. To do so, the processing apparatus 130 calculates the average of the service-delivery-impact score, the enterprise-impact score, and the operational-impact score for each of the processes. The average of these scores is the average of the service-delivery-impact score. Column 720 lists the average-criticality-component score for each of the processes listed in column 704.

Then, the modeling application 160 instructs the processing apparatus 130 to access the exemplary component-to-criticality conversion table 800 of FIG. 8 to convert each average-criticality-component score to a criticality score. Column 804 lists three exemplary ranges of average-criticality-component scores. Column 808 lists three corresponding exemplary criticality scores. Each criticality score of column 808 correspond to a range of average-criticality-component scores of column 804. To convert an average-criticality-component score to a criticality score, the processing apparatus 130 determines which of the three ranges of column 804 the average-criticality-component score falls within, and then identifies the corresponding criticality score of column 808. For example, as indicated in column 720 of FIG. 7, the process of notification has an average-criticality-component score of 1.33, which, as indicated in columns 804 and 808 of FIG. 8, falls within the range of average-criticality-components scores that corresponds with a criticality score of seventy-five. Accordingly, the process of notification has a criticality score of seventy-five. Also, for example, as indicated in column 720 of FIG. 7, the process of reconciliation has an average-criticality-component score of 1.67, which, as indicated in columns 804 and 808 of FIG. 8, falls within the range of average-criticality-components scores that corresponds with a criticality score of fifty. Accordingly, the process of reconciliation has a criticality score of fifty.

After calculating a redundancy score and a criticality score for each process, the modeling application 160 instructs the processing apparatus 130 to calculate a concentration-risk score for each process. However, before describing the process for calculating concentration-risk scores, a brief recap of redundancy scores and criticality scores will be provided. The redundancy score for a process represents the organization's capacity to move work on that process from one center to a backup center(s). For example, in the event a center is disrupted, a process with a high redundancy score is less likely to be disrupted than a process with a low redundancy score, because work on the process with the high redundancy score will more likely be moved from the disrupted center to a backup center. In the examples provided above, redundancy is measured on a scale of zero to one-hundred, where zero represents the most concentration risk because work on the process cannot be easily moved from the disrupted center to a backup center and where one-hundred represents the lest concentration risk because work on the process can be easily moved from the disrupted center to a backup center.

Turning now to criticality scores. The criticality score for a process represents the relative importance of that process to the organization. For example, if a process with a high criticality score is disrupted, the organization will be impacted more than if a process with a low criticality score were disrupted. Accordingly, it is good practice to ensure that processes having a high criticality score also have a high redundancy score. The redundancy score of a process of having a high criticality can be achieved by increasing the location dispersion of the centers working on that process, increasing migration capacity by spreading out employees that work the critical process among the dispersed centers, increase access to same systems by installing the same systems in as many of the dispersed centers as possible, and regularly conducting BCP testing.

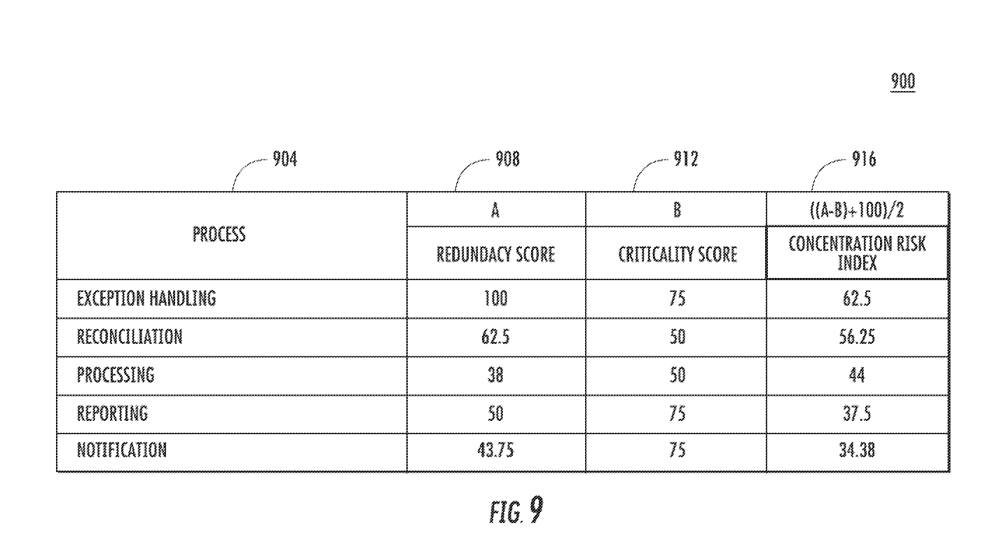

With that as a brief recap, concentration-risk scores and calculating concentration-risk scores will now be described in more detail with reference to FIG. 9. Column 904 of FIG. 9 lists the same five processes that were listed in column 404 of FIG. 4 and column 704 of FIG. 7. Column 908 lists the redundancy scores calculated according to process 300. The redundancy scores of column 908 are the same redundancy scores (but in a different order) provided in column 430 of FIG. 4. Column 912 lists the criticality scores calculated according to process 600. The criticality scores of column 912 are the same criticality scores (but in a different order) provided in column 720 of FIG. 7. Column 916 lists the concentration-risk scores. According to an embodiment, the modeling application 160 instructs the processing apparatus 130 to calculate a concentration-risk score for each of the processes by respectively inputting the redundancy scores and criticality scores into the exemplary concentration-risk equation provided in column 916 of table 900, where A is the redundancy score and B is the criticality score. Concentration-risk scores, according to some embodiments, are based on a scale of zero to one-hundred, where zero is the lowest concentration risk and one-hundred is the highest concentration risk. A concentration-risk score of fifty indicates that process is exactly at threshold for acceptable concentration risk. For example, if a process's concentration-risk score increases from fifty, then the process changes from having acceptable concentration risk to unacceptable concentration risk. A process having a concentration-risk score of fifty or below has acceptable concentration risk, whereas a process having a concentration-risk score above fifty has unacceptably high concentration risk.

Column 916 lists the processes in rank order from the process having the highest concentration-risk score to the process having the lowest. The organization's decision-makers can quickly glean from the concentration-risk scores of table 900 that the processes of exception handling and reconciliation have unacceptably high concentration risk and that all other processes have acceptable concentration risk. After identifying the processes of exception handling and reconciliation as having unacceptably high concentration risk, the organization's decision-makes can then determine the primary causes of the high concentration risk by reviewing table 400 of FIG. 4 and table 700 of FIG. 7. Regarding table 400, a decision-maker can quickly glean that the processes of exception handling and reconciliation have the highest redundancy scores. What's more, the decision-makers can glean ways to improve those processes redundancy scores.

As indicated in table 400, the process of exception handling has a low location-dispersion score because all of its employees are located in the same city, Charlotte. Further, because all of its employees are in Charlotte, the process of exception handling has 0% migration capacity and 0% access to same systems. Accordingly, to decrease concentration risk, decision makes can open another center in a different city, location, or country. As indicated in table 700, the process of exception handling has a relatively low criticality score. Accordingly, to decrease concentration risk to an acceptable level, the decision makers do not have to increase the redundancy score by quite as much as they would if exception handling had a higher criticality score. Accordingly, instead of opening a backup center in another country, which would be expensive, the decision makers can open a backup center in a different city or location. Further, if the decision-makers open more than one backup center, they do not have to install the same systems in all of the backup systems, because an access to same systems score of 100% is not necessary to decrease concentration risk to an acceptable level. Nor do they have to reassign many employees from Charlotte to the newly created backup centers.

Also, as indicated in table 400, the process of reconciliation has the second worst (i.e., highest) redundancy score. Because reconciliation has a higher criticality score than exception handling, it has to have a lower (i.e., better) redundancy score than reconciliation in order to have an acceptable concentration-risk score. To reduce reconciliation's redundancy score, the decision makers could open a backup center in a country outside of the organization's home country, thereby increasing the location dispersion score from three to four. However, the cheapest option would likely be to increase reconciliation's migration capacity by relocating one employee from the largest center in Charlotte to the backup center in Anaheim.

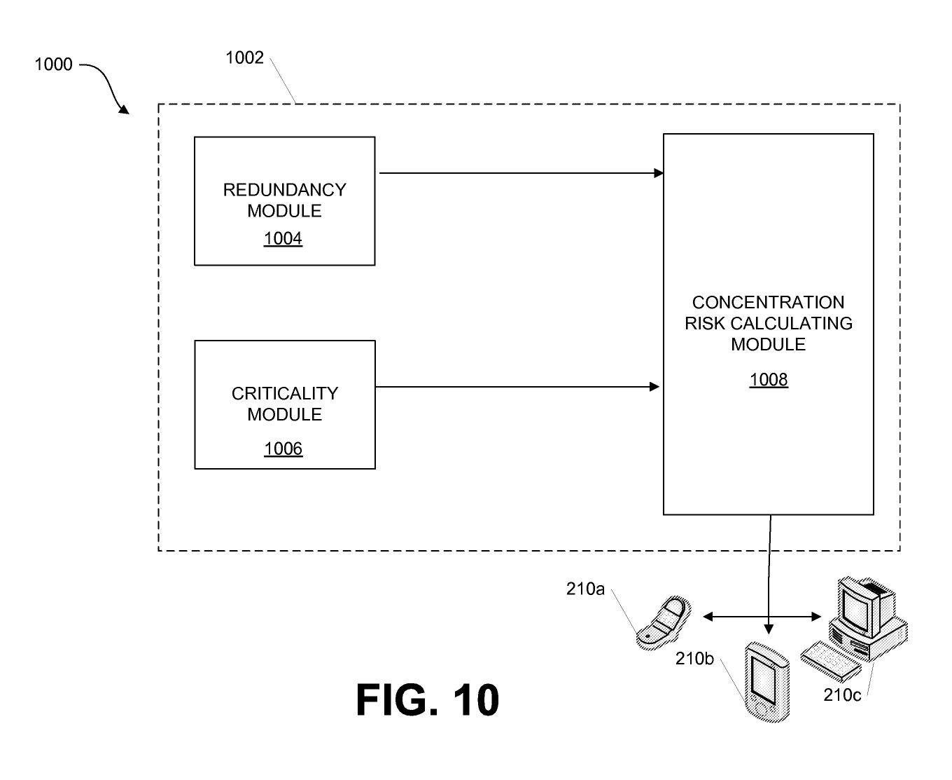

FIG. 10 illustrates one example concentration risk modeling system 1000 according to at least some aspects described above and additional aspects below. As discussed above, the concentration risk modeling system may be located within an organization, such as organization 1002, that may be implementing the system. The system 1000 may include a redundancy score module 1004 that may calculate a redundancy score for a process within an organization. For instance, the redundancy score module may calculate a redundancy score for a work process (or plurality of work processes) performed by or at a center or location within an organization. As discussed above, the redundancy score or redundancy, as used herein, may refer to an organization's capacity to move work (or a work process) from one center to another center in the even of a disruption in one of the centers. For instance, redundancy, and, accordingly, the redundancy score as described herein, may refer to an organizations' ability to move a work process from a primary center of operation to a backup center in the event the primary center experiences a disruption. For example, if work process A is performed at Center 1, redundancy may refer to the organization's ability to move work process A to Center 2 in the event that Center 1 experiences a disruption such as a power outage, loss of network capability, etc. One example arrangement for calculating a redundancy score for a work process and/or center, such as based on a number or percentage of resources associated with the process, will be discussed more fully below.

The concentration risk modeling system 1000 may further include a criticality score module 1006 for calculating a criticality score for a work process within an organization. As discussed above, the term “criticality” as used herein may refer to how important a particular work process is to the organization. For instance, criticality, according to at least some aspects of the disclosure, considers the impact on the organization's customers if a particular process is disrupted, the impact the organization as a whole if a particular process is disrupted, and the impact on the organization's operational continuity if a particular process is disrupted. Calculation of the criticality score is discussed above and will be discussed more fully below.

The redundancy score module 1004 and criticality score module 1006 transmit scores for a work process within a center of an organization to a concentration risk calculating module 1008. The concentration risk calculating module 1008 may combine the redundancy score and criticality score to obtain a concentration risk score for a work process or plurality of work processes. In some examples, a concentration risk score may be calculated for each center or location in which the process is performed. The concentration risk score may be transmitted to a user via one or more user computing devices 1010a-1010c, such as a user mobile device 1010a, such as a smart phone, cell phone, etc., a user personal digital assistance (PDA) 1010b, and/or a user computer terminal 1010c (e.g., laptop, desktop, notebook, etc.).

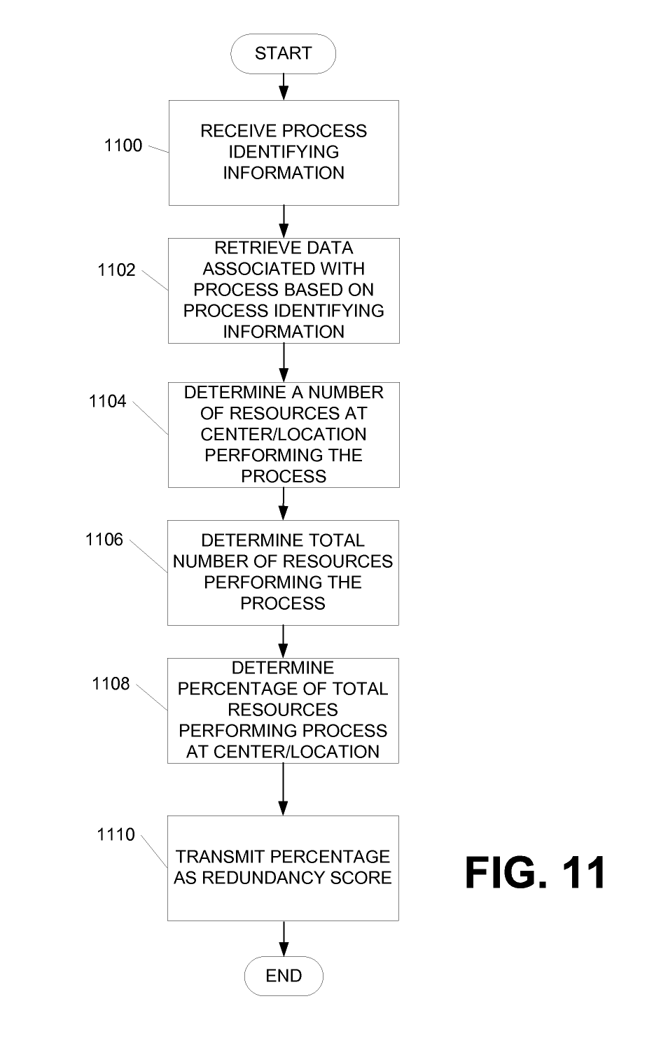

FIG. 11 illustrates one example method of calculating a redundancy score. As mentioned above, the redundancy score may be based on a number or percentage of resources performing a work function. For instance, the redundancy score may be based on a number or percentage or resources, such as employees, services, equipment, hardware, and the like. In step 1100, process identifying information is received, for instance, at a concentration risk modeling system (e.g., 110 in FIG. 1, 1000 in FIG. 10). The process identifying information may, as discussed above, identify one or more work processes for which a redundancy score is being calculated. In step 1102, data associated with the identified work process may be retrieved. In some examples, the data retrieved may include data relating to number of resources associated with a process. In step 1104, a number of resources associated with a process at a center may be determined. For instance, if work process B is performed at four (4) centers within an organization, the number of resources associated with work process B within at least one of the centers may be determined. In some examples, a number of resources associated with the work process at each center may be determined.

In step 1106, a total number of resources within the organization associated with the work process may be determined. In some examples, the total number of resources may be the sum of the number of resources associated with the work process at each center. In step 1108, a percentage of total resources associated with the work function at the at least one center may be determined. In examples in which the number of resources at each center has been determined, the percentage for each center may be calculated. This percentage may be calculated using the following equation:

$$\frac{Number of Resources At Center}{Total Number of Resources} * 100 = Redundancy Score$$

In step 1110, this percentage may be transmitted as the redundancy score for the center, for instance, to a concentration risk modeling system or concentration risk calculating module for further processing.

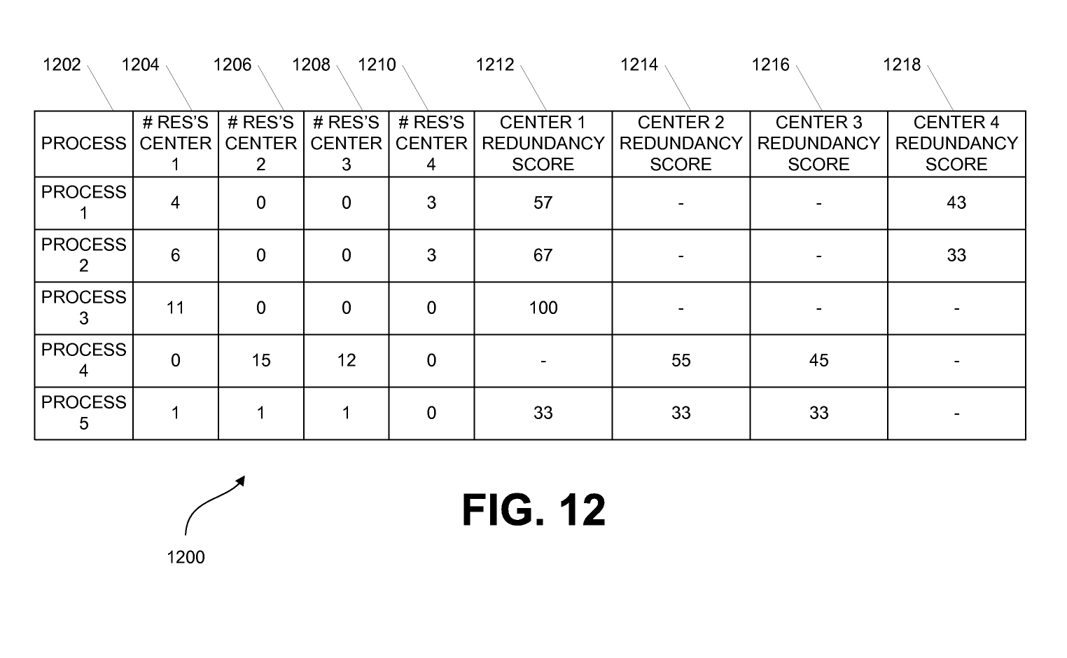

FIG. 12 illustrates a table 1200 having example redundancy scores for various processes, centers, etc. based on the above-discussed method of calculating redundancy scores. In column 1202, various work processes may be identified. For instance, similar to the arrangement discussed above, work processes may include notification, reconciliation, exception handling, processing, reporting, and the like. Column 1204-1210 indicate a number of resources associated with each process at various centers. For instance, column 1204 indicates a number of resources associated with the identified processes at Center 1, while column 1206 provides a number of resources associated with the processes at Center 2. Columns 1208 and 1210 provide a number of resources associated with the processes at Center 3 and Center 4, respectively.

Columns 1212-1218 provide a redundancy score for each center for each process. This redundancy score may be a percentage of the total resources associated with the process at each center (e.g., the number of resources at each center divided by a sum of the value in columns 1204-1210 and multiplied by 100). For example, process 1 has seven total resources associated with the process (sum of 4 in Center 1 plus 3 in Center 4). Accordingly, a redundancy score for Center 1 for process 1 may be:

$$\frac{4 Resources At Center 1}{7 Total Resources} * 100 = 57 \%$$

This redundancy score may be combined with a determined criticality score to determine a concentration risk score. As discussed above, criticality scores may be calculated based on three criticality components: service-delivery impact; enterprise impact; and operational impact. FIGS. 5-8 and associated description provide additional details for calculating the criticality score. In some examples, this criticality score may be transmitted to a concentration risk module for further processing.

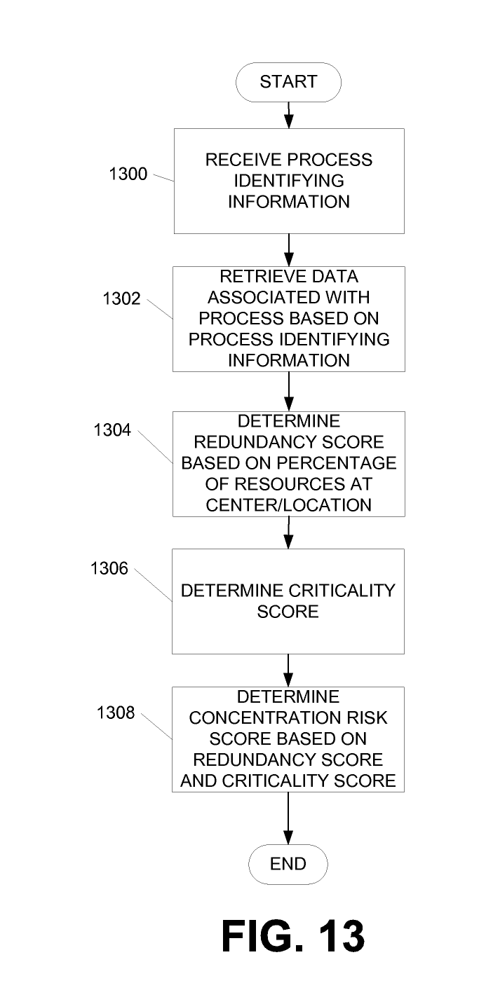

For instance, FIG. 13 illustrates one example method of calculating a concentration risk score according to various aspects described herein. In step 1300, process identifying information may be received identifying a work process. In step 1302, data associated with the work process may be retrieved. The data retrieved may include data associated with calculating a redundancy score, criticality score, etc. as described above. In step 1304, a redundancy score may be determined based on a percentage of total resources associated with the identified process at a center. Determining the redundancy score may be performed according to the method shown in FIG. 11 and described above. In step 1306, a criticality score may be determined. The criticality score may be determined as described above with respect to FIGS. 5-8.

In step 1308 a concentration risk score may be determined based on the redundancy score and criticality score. In some examples, the concentration risk score may be calculating according to the following equation:

$$\frac{( \begin{matrix}Redundancy Score - \\ Criticality Score\end{matrix} ) + 100}{2} = Concentration Risk Score$$

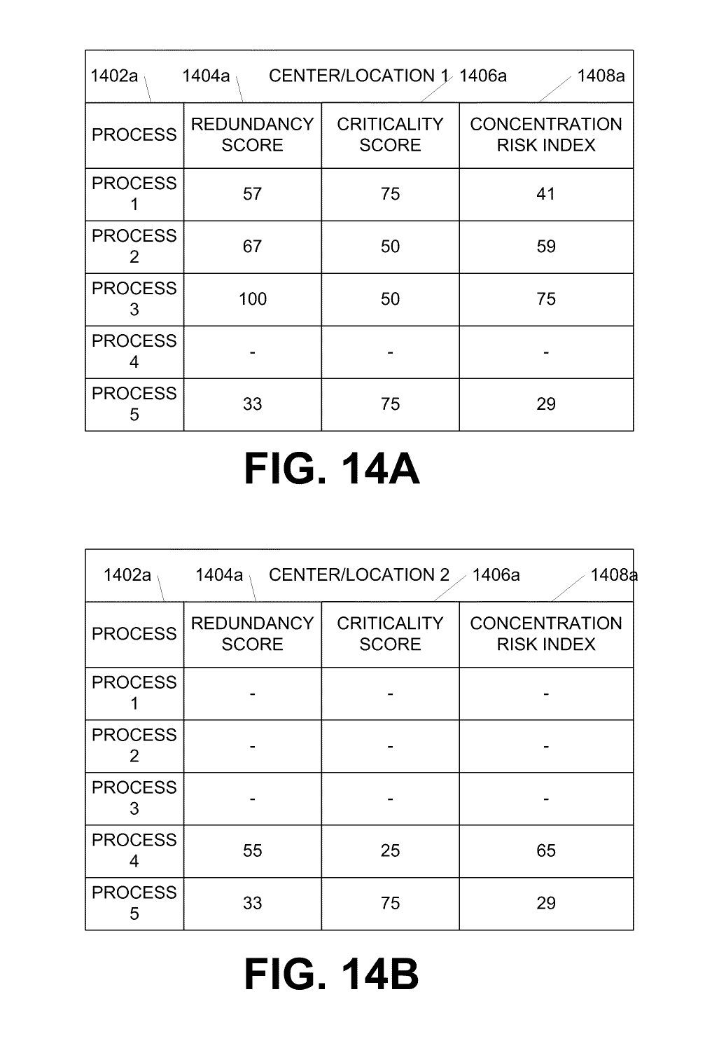

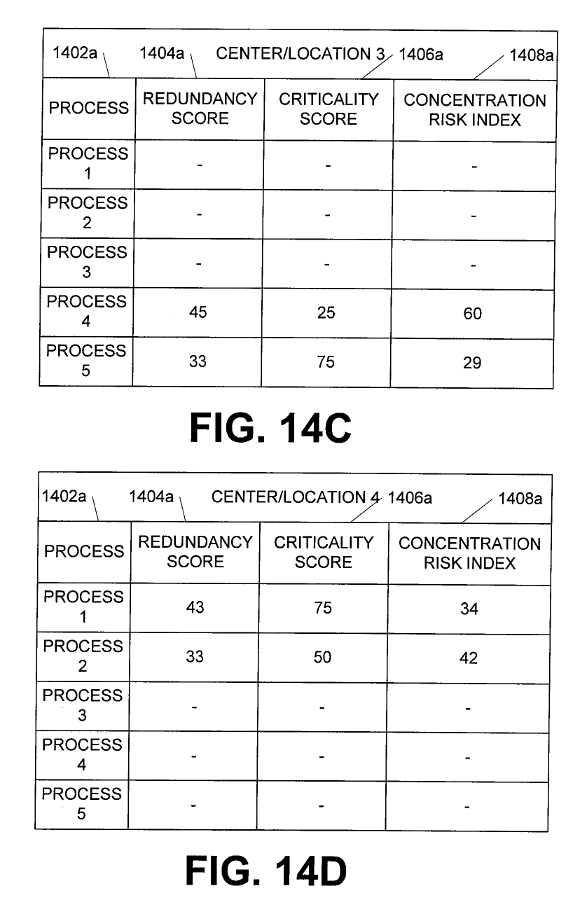

FIGS. 14A-14D illustrate various examples of concentration risk scores for the processes and centers described in FIG. 12 with respect to redundancy scores. For instance, FIG. 14A illustrates the concentration risk score for various processes for Center 1. Column 1402a provides various processes for which the concentration risk score is calculated. Column 1404a provides the redundancy score for each process for Center 1, as determined based on the systems and methods described above and, in particular with respect to the method shown in FIG. 11. Column 1406a illustrates the criticality score as calculated for each process in Center 1 and column 1408a provides the concentration risk score for each process within Center 1. For instance, with respect to process 3 for Center 1, the determined redundancy score is 100 and the determined criticality score is 50. Accordingly, applying the above described equation, the concentration risk score is:

$$\frac{( 100 - 50 ) + 100}{2} = 75$$

FIGS. 14B-14D illustrate concentration risk scores for Centers 2-4, respectively. Information relating to the redundancy scores, criticality scores, etc. for work processes in each center are provided, similar to those provided in FIG. 14A. Further, the concentration risk score (as shown in columns 1408b-1408d) may be calculated similarly to the example described above with respect to FIG. 14A.

The calculation of the concentration risk score using a redundancy score based on a number of resources and percentage of resources at a center may simplify the calculation of the risk score and may provide more consistent, repeatable results. Further, by having fewer variables in the redundancy score calculation, there is less opportunity for error, misrepresentation of data, inaccurate data, etc.

Various aspects associated with the concentration risk modeling system and calculation of redundancy score, criticality score, concentration risk score may be used in whole or in part with various other aspects, methods, etc. for calculating the various scores. Nothing in the specification and figures should be viewed as limiting the calculation of redundancy score, criticality score, and/or concentration risk score to the arrangements shown. Rather, the scores may be calculated according to any method described herein, including a combination of methods, without departing from the disclosure.

While certain exemplary embodiments have been described and shown in the accompanying drawings, it is to be understood that such embodiments are merely illustrative of and not restrictive on the broad disclosure, and that this disclosure not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the disclosure. Therefore, it is to be understood that, within the scope of the appended claims, the disclosure may be practiced other than as specifically described herein.

The methods and features recited herein may further be implemented through any number of non-transitory computer readable media that are able to store computer readable instructions. Examples of non-transitory computer readable media that may be used include RAM, ROM, EEPROM, flash memory or other memory technology, CD-ROM, DVD, or other optical disc storage, magnetic cassettes, magnetic tape, magnetic storage and the like.

While illustrative systems and methods described herein embodying various aspects are shown, it will be understood by those skilled in the art that the disclosure is not limited to these embodiments. Modifications may be made by those skilled in the art, particularly in light of the foregoing teachings. For example, each of the elements of the aforementioned embodiments may be utilized alone or in combination or sub-combination with the elements in the other embodiments. It will also be appreciated and understood that modifications may be made without departing from the true spirit and scope of the present disclosure. The description is thus to be regarded as illustrative instead of restrictive on the present disclosure.

What is claimed is:

1. A method, comprising:
receiving, by a concentration risk calculating computing device, work process identifying information;
receiving, by the concentration risk calculating computing device, data associated with a work process associated with the work process identifying information;
determining, by the concentration risk calculating computing device, a redundancy score of the work process;
determining, by the concentration risk calculating computing device, a criticality score of the work process; and
determining, by the concentration risk calculating computing device, a concentration risk score based on the determined redundancy score and the determined criticality score.

2. The method of claim 1, wherein the redundancy score of the work process is based on a percentage of the total number of resources performing the work process at a first center.

3. The method of claim 1, wherein the redundancy score of the work process is based solely on the percentage of the total number of resources performing the work process at a first center.

4. The method of claim 1, wherein the concentration risk score is calculated according to:
$$\frac{( Redundancy Score - Criticality Score ) + 100}{2} .$$

5. The method of claim 1, wherein the criticality score is based at least in part on a received service-delivery impact score and a received enterprise-impact score.

6. The method of claim 1, wherein the criticality score is based at least in part on a received access-to-same-systems score.

7. A method, comprising:
receiving, by a concentration risk calculating computing device, work process identifying information;
receiving, by the concentration risk calculating computing device, data associated with a work process identified by the work process identifying information;
determining, by the concentration risk calculating computing device, a first redundancy score of the work process, wherein the first redundancy score includes a percentage of total resources performing the work process for an organization at a first center of the organization;
determining, by the concentration risk calculating computing device, a first criticality score of the work process at the first center; and
determining, by the concentration risk calculating computing device, a first concentration risk score for the work process at the first center based on the determined first redundancy score and the determined first criticality score.

8. The method of claim 7, wherein the first redundancy score is based solely on the percentage of total resources performing the work process at the first center.

9. The method of claim 7, wherein the first concentration risk score is calculated according to:
$$\frac{( Redundancy Score - Criticality Score ) + 100}{2}$$

10. The method of claim 7, further including:
determining, by the concentration risk calculating computing device, a second redundancy score of the work process, wherein the second redundancy score includes a percentage of total resources performing the work process for the organization at a second center of the organization;
determining, by the concentration risk calculating computing device, a second criticality score of the work process at the second center; and
determining, by the concentration risk calculating computing device, a second concentration risk score for the work process at the second center based on the determined second redundancy score and the determined second criticality score.

11. The method of claim 10, further including comparing the first concentration risk score to the second concentration risk score to identify an effect of a disruption on at least one of the first center and the second center.

12. The method of claim 10, wherein the first center and the second center are in different locations.

13. One or more non-transitory computer readable media storing computer readable instructions that, when executed, cause an apparatus to:
receive, by a concentration risk calculating computing device, work process identifying information;
receive, by the concentration risk calculating computing device, data associated with a work process identified by the work process identifying information;
determine, by the concentration risk calculating computing device, a first redundancy score of the work process, wherein the first redundancy score includes a percentage of total resources performing the work process for an organization at a first center of the organization;
determine, by the concentration risk calculating computing device, a first criticality score of the work process at the first center; and
determine, by the concentration risk calculating computing device, a first concentration risk score for the work process at the first center based on the determined first redundancy score and the determined first criticality score.

14. The one or more non-transitory computer readable media of claim 13, wherein the first redundancy score is based solely on the percentage of total resources performing the work process at the first center.

15. The one or more non-transitory computer readable media of claim 13, wherein the first concentration risk score is calculated according to:
$$\frac{( Redundancy Score - Criticality Score ) + 100}{2}$$

16. The one or more non-transitory computer readable media of claim 13, further including instructions that, when executed, cause the apparatus to:
determine, by the concentration risk calculating computing device, a second redundancy score of the work process, wherein the second redundancy score includes a percentage of total resources performing the work process for the organization at a second center of the organization;
determine, by the concentration risk calculating computing device, a second criticality score of the work process at the second center; and
determine, by the concentration risk calculating computing device, a second concentration risk score for the work process at the second center based on the determined second redundancy score and the determined second criticality score.

17. The one or more non-transitory computer readable media of claim 16, wherein the first center and the second center are in different locations.

18. An apparatus, comprising:
a processor; and
memory operatively coupled to the processor and storing computer readable instructions that, when executed, cause the apparatus to:
receive, by a concentration risk calculating computing device, work process identifying information;
receive, by the concentration risk calculating computing device, data associated with a work process identified by the work process identifying information;
determine, by the concentration risk calculating computing device, a redundancy score of the work process, wherein the redundancy score includes a percentage of total resources performing the work process for an organization at a first center of the organization;
determine, by the concentration risk calculating computing device, a criticality score of the work process at the first center; and
determine, by the concentration risk calculating computing device, a concentration risk score for the work process at the first center based on the determined redundancy score and the determined criticality score.

19. The apparatus of claim 18, wherein the redundancy score is based solely on the percentage of total resources performing the work process at the first center.

20. The apparatus of claim 18, wherein the concentration risk score is calculated according to:
$$\frac{( Redundancy Score - Criticality Score ) + 100}{2}$$

21. The apparatus of claim 18, wherein the criticality score is based at least in part on a received service-delivery impact score and a received enterprise-impact score.

22. The apparatus of claim 18, wherein the criticality score is based at least in part on a received access-to-same-systems score.
